(19) United States
(12) Patent Application Publication
(10) Pub. No.: US 2003/0144896 A1
(43) Pub. Date: Jul. 31, 2003

(54) System of demand fulfillment and a method therefor

(75) Inventors: Heng-An Ko, Hsin-Chu City (TW); Chiang-Chih Chien, Hsin-Chu City (TW); Long-Yi Lee, Kaohsiung City (TW)

Correspondence Address: MERCHANT & GOULD PC, P.O. BOX 2903, MINNEAPOLIS, MN, 55402-0903, US

(73) Assignee: UNITED MICROELECTRONICS CORP., Hsin-Chu City (TW)

(21) Appl. No.: 10/060,459

(22) Filed: Jan. 30, 2002

(51) Int. Cl. G06F 17/60

(52) U.S. Cl. 705/10

(57) ABSTRACT

A method and a system of demand fulfillment associated with available to promise (ATP) and capable to promise (CTP) are provided. The system of demand fulfillment comprises a memory and a processor coupled each other. The memory can store a forecast order model representing a customer and a product. The product uses a product demand module comprising a forecast value representing a forecasted amount booked by the customer. An allocated value represents a planned supply amount and a support value represents a shared amount. A processor is operable to compute for the product and the ATP for the product according to the CTP and the forecast value. The ATP comprises the allocated value and the support value. The process can adjust the support value according to the CTP and at least a business criterion, and fulfill a request confirmation according to the allocated value and the support value. The method executed associated with the system could reduce the cycle time of order confirmation.

### BACKGROUND OF THE INVENTION

1. Field of the Invention

This invention relates in general to the fields of demand management, and capacity management. More particularly, the present invention relates to a system and a method for real-time demand fulfillment.

2. Description of the Prior Art

Manufacturers produce products for sale to customers. In the order confirm status, customers place demands on manufacturers. A customer demand may consist of a request for a particular quantity of a product by a specific date. This date and quantity information may be collectively referred to as the “order” or “customer request”.

Especially in Foundry Wafer FAB, when receiving an order with a reasonable shipping request date, FAB planner has to consider the standard cycle time and current resource capacity and product mix status to confirm this order. This type of procedure of order confirm belongs to static planning, and it's very hard to reflect to the real dynamic wafer production circumstance.

To better meet customer demand, Foundry Wafer FAB must arrange equipment and capacity plan before receiving customer orders. The capacity arrangement is based on projections called “forecast orders”. A FAB planner made production plan based on these forecast orders is referred to as “available-to-promise product” or “ATP”. ATP may consists of quantities of products with associated dates that the products are scheduled to be available for fulfill to the order. FAB planner assigns individual ATP for each customer based on customer's forecast orders to reflect customer's demand in future.

Traditional methods for demand management and fulfillment have several problems. First, such methods and systems are not integrated. Several different tools may be required to implement the entire demand management and fulfillment strategy. Second, such traditional systems and methods are not dynamic. Traditional method for generate the ATP is evaluated by planner. It is difficult for the manufacturer to react to changing circumstances and update the plan. Third, order promising to customers is often done based upon an infeasible plan, thus, the cycle time of confirming an order might take 1 to 2 days in average. Therefore traditional method and system is difficult to real-time confirm customer's demand or order request.

### SUMMARY OF THE INVENTION

In accordance with the present invention, a demand management method and system for providing real-time fulfillment confirm.

Accordingly, one object of the present invention is to provide a method for real-time demand fulfillment with AATP (Allocated-Available-To-promise)-CTP (Capable-To-Promise).

Another object is to reduce order confirm cycle time from days to seconds through dynamic ATP management.

In accordance with the present invention, a method and a system of demand fulfillment associated with available to promise (ATP) and capable to promise (CTP) are provided. The system of demand fulfillment comprises a memory and a processor coupled each other. The memory can store a forecast order model representing a customer and a product. The product uses a product demand module comprising a forecast value representing a forecasted amount booked by the customer. An allocated value represents a planned supply amount and a support value represents a shared amount. A processor is operable to compute for the product and the ATP for the product according to the CTP and the forecast value. The ATP comprises the allocated value and the support value. The process can adjust the support value according to the CTP and at least a business criterion, and fulfill a request confirmation according to the allocated value and the support value. The method executed associated with the system could reduce the cycle time of order confirmation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram illustrating a system of demand management for real-time fulfillment in accordance with the present invention;

FIG. 2 is a schematic flow chart illustrating the method in accordance to the present invention; and

FIGS. 3A and 3B dedicate a preferred embodiment of the present invention;

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

The present invention provides a method and a system of demand fulfillment associated with available to promise (ATP) and capable to promise (CTP). The system of demand fulfillment comprises a memory and a processor coupled each other. The memory can store a forecast order model representing a customer and a product. The product uses a product demand module comprising a forecast value representing a forecasted amount booked by the customer. An allocated value represents a planned supply amount and a support value represents a shared amount. A processor is operable to compute for the product and the ATP for the product according to the CTP and the forecast value. The ATP comprises the allocated value and the support value. The process can adjust the support value according to the CTP and at least a business criterion, and fulfill a request confirmation according to the allocated value and the support value. The method executed associated with the system could reduce the cycle time of order confirmation.

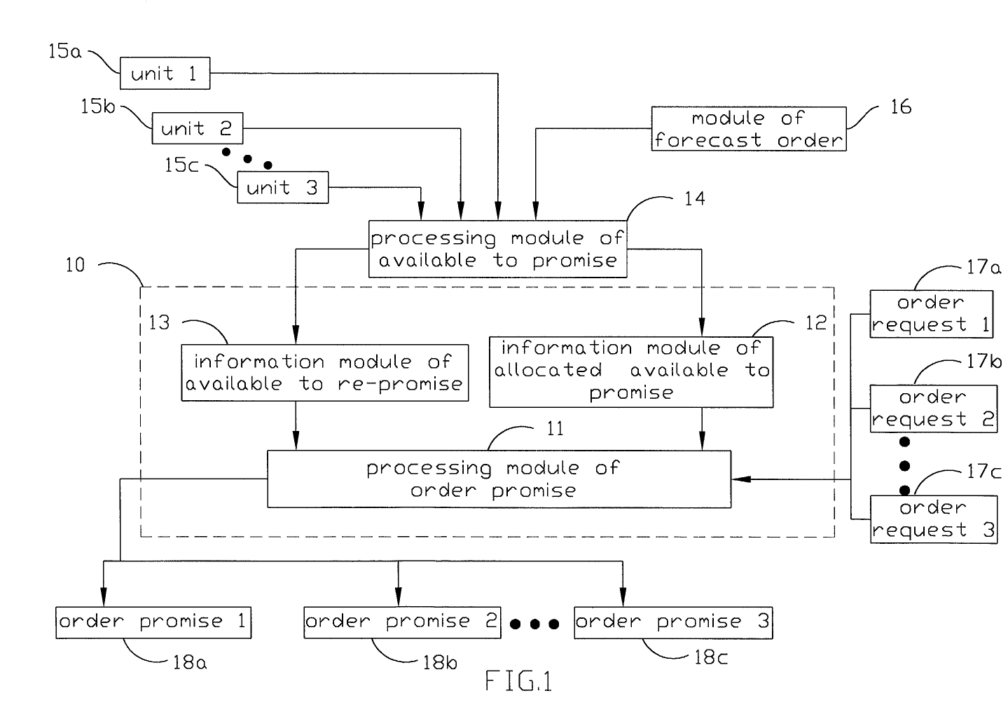

FIG. 1 is a block diagram illustrating a system of demand management for real-time fulfillment in accordance with the present invention. The system of demand management 10 comprises a processing module of order fulfillment 11, an information module of allocated-available-to-promise (AATP) 12 and an information module of available-to-re-promise (r-ATP) 13. To be specific, each module in the system of demand management 10 may have individual hardware or shared hardware. The so-called hardware may consist of a storage device, such as a hard disk; a memory device, such as DRAM; a processor, such as CPU; or related peripheral circuits. Furthermore, software for each module in the system of demand management 10 may be built on a same system platform or different system platform wherein may share information with others.

Furthermore, the information modules of AATP 12 and r-ATP 13 are connected to the processing module of ATP 14. After processing the capable-to-promises by all production units 15a to 15c and the forecast orders in information module of forecast order 16, the processing module of ATP 14 is responsible for generating the data or results of the information modules of AATP 12 and r-ATP 13. The processing module of ATP 14 could be built together with the system of demand management 10 in a single hard system, such as a server, or built in an individual hard system. Furthermore, any production unit 15a, 15b, or 15c, could be any equipment, production machine, material or power resource. Furthermore, the information module of forecast order 16 could be a database or server of the storage and management for the forecast orders.

One of features of the present invention is related to the information or data of AATP and r-ATP (in the information modules of AATP 12 and r-ATP 13) generated by the processing module of ATP 14. Generally, the customers submit the contents of the forecast orders, such as types of product or quantities, more than what they want. For manufactures, some production capacities may idle and be insufficiently utilized if they are planed according to the forecast orders from the customers. In the present invention, the AATP and r-ATP in the information modules of AATP 12 and r-ATP 13 provide a resolution of the above condition. In the plan and allocation procedure of the production capacity, the currently available production capacity is generated by deducting the consumption of those confirmed orders. The processing module of ATP 14 generates the AATPs and r-ATPs according to the currently available production capacity and the forecast orders, and then outputs the AATPs and r-ATPs to the information modules of AATP 12 and r-ATP 13, individually. For any one of forecast orders, the corresponded AATP would satisfy the most demand for the corresponding forecast order. On the other hand, the corresponded r-ATP would support the rest demand for the corresponding forecast order, wherein the manufacturer supposes the rest demand is an excess part of demand (over booking) for the corresponding customer.

In the present invention, there are multitudes of functions provided by the r-ATPs. When the finally confirmed demand of the corresponded forecast order is more than one satisfied by the corresponded AATP, the corresponded r-ATP is capable of demand support to satisfy the finally confirmed demand. Furthermore, when the finally confirmed demand of the corresponded forecast order is even more than one originally requested by the corresponded forecast order, the other r-ATPs would be utilized to support the finally confirmed demand of the corresponded forecast order. Furthermore, the r-ATPs would be utilized to support those unforeseen orders not planed by the manufacturer.

Thus, no matter what is requested, a finally confirmed demand of forecast order or unforeseen order, the processing module of order fulfillment 11 could process the current orders according to the information modules of AATP 12 and r-ATP 13 and determines whether the current orders could be fulfilled or not. Then the processing module of order fulfillment 11 would send out the corresponded response for each order 18a˜c to confirm the effects of the current orders.

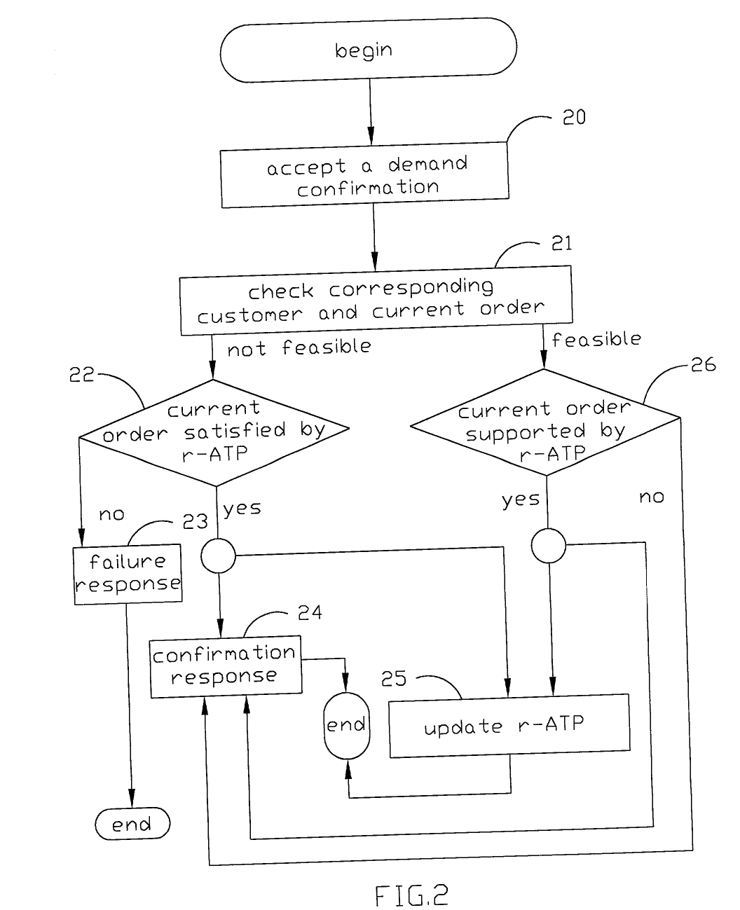

FIG. 2 is a schematic flow chart illustrating the method in accordance to the present invention. The customers could send their forecast orders or confirmation requests of order on the website of manufacturer through the Internet or e-business method (it is a business criterion between the customers and manufacturer). In the present invention, when the processing module of order fulfillment receives a confirmation request of order (current order) from a customer (step 20), the manufacturer would compare the current order with every ATP for checking the corresponding customer and fulfillment of the demand on the current order (step 21). On condition of an unforeseen customer or excessive demand over one of the original forecast order, the processing module of order fulfillment further checks the demand of the current order with the r-ATPs (step 22). If the demand of the current order is not satisfied with the r-ATPs, the response of failure for the current order would be sent by the processing module of order fulfillment (step 23). Alternatively, the response of promise for the current order would be sent for confirmation of the current order by the processing module of order fulfillment (step 24). Furthermore, the r-ATPs would be updated by deducting the consumption of r-ATPs for the current order (step 25).

On the other hand, when the demand of the current order could be corresponded to a specific ATP, it would be further checked according to the corresponded AATP for the request of support by the corresponded r-ATP (step 26). If it is not necessary to consume the capacity of r-ATPs, the response of promise for the current order would be sent for confirmation of the current order by the processing module of order fulfillment (step 24). Alternatively, in addition to the delivery of the response of promise (step 24), the r-ATPs would be updated by deducting the consumption of r-ATPs for the current order (step 25).

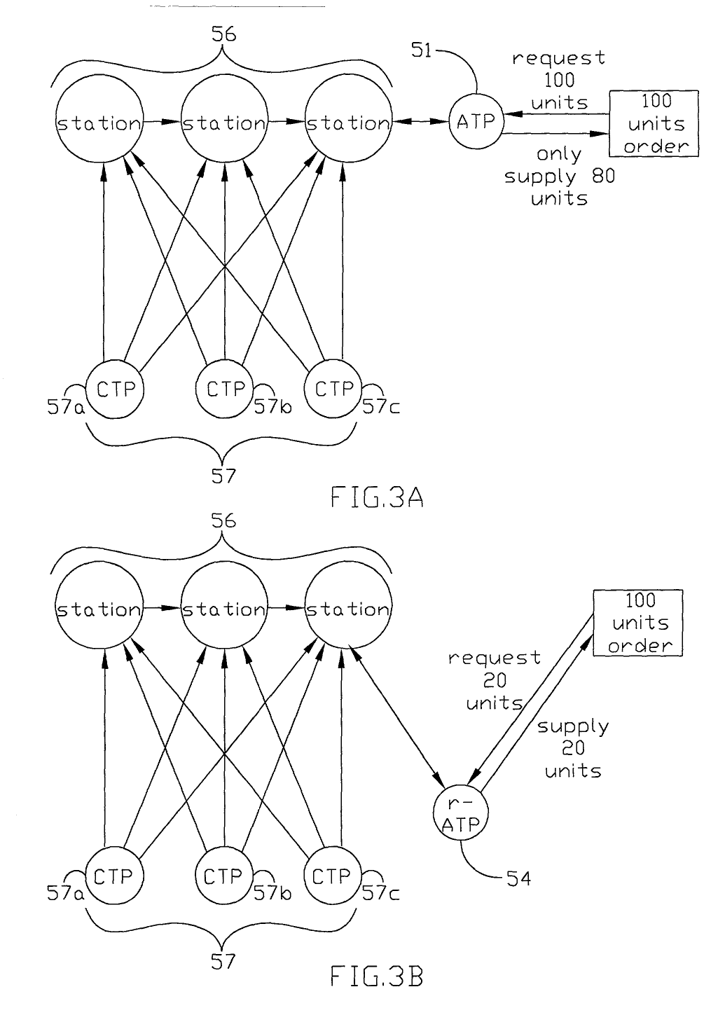

FIGS. 3A-3B are schematic diagrams illustrating the flow chart of order fulfillment in a preferred embodiment in accordance with the present invention. Shown in FIG. 3A, the 100 units demand of product is requested by a current order and then processed by the demand management system. Initially, the corresponded ATP 51 is available for the demand of the current order, wherein the capacity of 80 units for the product is provided. The capacity of 80 units is provided by CTP of the production units 57a˜c which are related to a corresponded manufacture group 56 of the product. The corresponded manufacture group 56 represents the stations for manufacture process of the product, wherein it is linked to at least one production unit 57a, b, or c.

On the other hand shown in FIG. 3B, the demand management system would get the capacity of the rest 20 units from pool ATP 54 to fulfill the current order. Thus, the demand management system could send a real-time confirmation for the current order. In accordance with the present of invention, the cycle time of order confirmation could be reduced from days to seconds.

Although specific embodiments have been illustrated and described, it will be obvious to those skilled in the art that various modifications may be made without departing from what is intended to be limited solely by the appended claims.

What is claimed is:

1. A system of demand fulfillment associated with available to promise (ATP) and capable to promise (CTP), said system of demand fulfillment comprising:
a memory operable to store a forecast order model which represents a customer and a product, said product being represented using a product demand module comprising:
a forecast value representing a forecasted amount of said product booked by said customer;
an allocated value representing a planned supply amount of said product for said customer; and
a support value representing a shared amount of said product for said customer; and
a processor coupled to said memory and operable to:
compute for said product in said forecast order model, said ATP for said product according to said CTP and said forecast value, said ATP comprising said allocated value and said support value;
adjust said support value for said product according to said CTP and at least a business criterion; and
fulfill a request confirmation for said customer according to said allocated value and said support value.

2. The system of demand fulfillment according to claim 1, wherein said business criterion comprises a current order criterion wherein a current order is request.

3. The system of demand fulfillment according to claim 2, wherein said request confirmation is corresponded to said current order.

4. The system of demand fulfillment according to claim 2, wherein said processor is further operable to compare said current order criterion with said forecast order module.

5. The system of demand fulfillment according to claim 1, wherein said business criterion comprises a confirmation demand for said forecast order module, wherein said confirmation demand comprises a request amount for said product.

6. The system of demand fulfillment according to claim 5, wherein said processor adds said support value when said request amount is less than said allocated value.

7. The system of demand fulfillment according to claim 5, wherein said processor deducts a consumed amount from said support value when a part of said support value is assigned to a part of said request amount.

8. The system of demand fulfillment according to claim 5, wherein said request confirmation is corresponded to said confirmation demand.

9. A system of demand fulfillment associated with available to promise (ATP) and capable to promise (CTP), said system of demand fulfillment comprising:
a memory operable to store a plurality of forecast orders wherein each comprises a customer and a product with a forecasted amount, each said product being represented using a product demand module comprising:
an allocated value representing a planned supply amount of each said product according to said ATP, said CTP and each said forecasted amount; and
a support value representing a shared amount of said each product for each said customer, said shared amount available to said customers and said products; and
a processor coupled to said memory and operable to:
compute for each said product in each said forecast order model, each said ATP for each said product according to said CTP and each said forecasted amount, each said ATP comprising each said allocated value and each said support value;
adjust said plurality of support values according to said CTP and at least a business criterion; and
fulfill a request confirmation according to each said allocated value and each said support value.

10. The system of demand fulfillment according to claim 9, wherein said request confirmation is corresponding to a current order when said business criterion comprises said current order.

11. The system of demand fulfillment according to claim 9, wherein said processor is further operable to accept said business criterion through an Internet.

12. The system of demand fulfillment according to claim 9, wherein said request confirmation is corresponding to one of said forecast orders.

13. A method for demand fulfillment associated with available to promise (ATP) and capable to promise (CTP), said method comprising:
storing a forecast order model which represents a customer and a product, said product being represented using a product demand module comprising:
a forecast value representing a forecasted amount of said product booked by said customer;
an allocated value representing a planned supply amount of said product for said customer; and
a support value representing a shared amount of said product for said customer;
computing for said product in said forecast order model, said ATP for said product according to said CTP and said forecast value, said ATP comprising said allocated value and said support value;
adjusting said support value for said product according to said CTP and at least a business criterion; and
fulfilling a request confirmation for said customer according to said allocated value and said support value.

14. The method according to claim 13, wherein said business criterion comprises a current order criterion wherein a current order is request.

15. The method according to claim 14, wherein said request confirmation is corresponded to said current order.

16. The method according to claim 14 further comprising comparing said current order criterion with said forecast order module.

17. The method according to claim 13, wherein said business criterion comprises a confirmation demand for said forecast order module, wherein said confirmation demand comprises a request amount for said product.

18. The method according to claim 17 further comprising adding said support value when said request amount is less than said allocated value.

19. The method according to claim 17 further comprising deducting a consumed amount from said support value when a part of said support value is assigned to a part of said request amount.

20. The method according to claim 17, wherein said request confirmation is corresponded to said confirmation demand.
